(19) United States
(12) Patent Application Publication
(10) Pub. No.: US 2003/0106752 A1
(43) Pub. Date: Jun. 12, 2003

(54) Vehicle damper assembly and method for reducing binding contact

(75) Inventors: Michael L. Oliver, Xenia, OH (US); William C. Kruckemeyer, Beavercreek, OH (US); Todd A. Bishop, Centerville, OH (US); Eric L. Jensen, Dayton, OH (US)

Correspondence Address: DELPHI TECHNOLOGIES, INC., Legal Staff, Mail Code: 482-204-450, 1450 W. Long Lake, P.O. BOX 5052, Troy, MI, 48098, US

(73) Assignee: DELPHI TECHNOLOGIES INC.

(21) Appl. No.: 10/011,694

(22) Filed: Dec. 7, 2001

(51) Int. Cl. F16F 9/53

(52) U.S. Cl. 188/267.2; 188/267.1

(57) ABSTRACT

The invention provides a vehicle damper assembly including a housing including a fluid carried therein, a piston slidably carried in the housing, and a rod operably attached to the piston. The piston includes a curved portion positioned adjacent a housing inner surface. The invention further provides a vehicle damper assembly including housing means for carrying a fluid, piston means from reducing binding contact with the housing means, and rod means for moving the piston means. The invention further provides a method of reducing binding contact in a vehicle damper assembly. A longitudinal radius is determined for a piston based on a housing inner surface. The piston is formed with a curved portion based on the longitudinal radius. The curved portion is positioned adjacent the housing inner surface.

### TECHNICAL FIELD OF THE INVENTION

The present invention relates generally to vehicular suspension systems. More particularly, the invention relates to a vehicle damper assembly and method for reducing binding contact.

### BACKGROUND OF THE INVENTION

Linear suspension dampers, such as shock absorbers and McPherson struts, may include a rod and piston moving within a housing. Suspension movements transmitted to the rod and piston may be dampened by a fluid carried within the housing. As the fluid flows between a piston outer surface and housing inner surface, a dampening friction force is generated. To ensure consistent and reliable damper performance, several design factors may be considered.

One consideration in damper design relates to friction and wear. Some current damper designs include a cylindrical piston sized to closely fit within a cylindrical housing. During damper operation, the piston may repeatedly contact the inner surface of the housing resulting in excessive wear. A small fluid-filled gap may be provided between the piston outer surface and housing inner surface to reduce friction and wear. The fluid-filled gap acts as a hydrodynamic “bearing” between the piston and housing engagement surfaces. Control of the fit and fluid flow gap size between the piston and housing is important in maintaining adequate hydrodynamic bearing. For example, sufficient narrowing of the flow gap size may compromise hydrodynamic bearing and result in excessive wear. Accordingly, it would be desirable for a damper design to provide adequate hydrodynamic bearing to minimize friction and wear.

Another consideration in damper design relates to damper assembly misalignment. During damper assembly, inherent process variation may result in a misalignment between the rod and outside surface of the piston. Typically, the fit and fluid gap between the piston and housing provides hydrodynamic bearing minimizing friction and wear. Misalignment of the parts, however, may compromise hydrodynamic bearing resulting in repeated contact between surfaces. The contact may produce excessive frictional wear thereby shortening damper lifespan. If the misalignment is sufficient, the piston may not be able to freely slide within the tube due to the binding contact. The binding contact may cause the piston to “seize” within the housing. Accordingly, it would be desirable for a damper design to reduce the consequences associated with damper assembly misalignment.

Therefore, it would be desirable to provide a vehicle damper assembly and method for reducing binding contact that overcomes the aforementioned and other disadvantages.

### SUMMARY OF THE INVENTION

One aspect of the present invention provides a vehicle damper assembly including a housing including a fluid carried therein, a piston slidably carried in the housing, and a rod operably attached to the piston. The piston includes a curved portion positioned adjacent a housing inner surface. The fluid may be magnetorheological fluid. The curved portion may include a longitudinal radius and/or form a barrel shape. The curved portion may contact the housing inner surface during operation of the vehicle damper assembly. The curved portion includes piston means for reducing binding contact and/or means for maintaining hydrodynamic bearing between the piston and the housing inner surface.

Another aspect of the invention provides a vehicle damper assembly including housing means for carrying a fluid, piston means for reducing binding contact with the housing means, and rod means for moving the piston means. The fluid may be magnetorheological fluid. The vehicle damper assembly may further include means for maintaining hydrodynamic bearing between the piston means and the housing means.

Another aspect of the invention provides a method of reducing binding contact in a vehicle damper assembly. A longitudinal radius is determined for a piston based on a housing inner surface. The piston is formed with a curved portion based on the longitudinal radius. The curved portion is positioned adjacent the housing inner surface. Hydrodynamic bearing may be maintained between the piston and the housing inner surface.

The foregoing and other features and advantages of the invention will become further apparent from the following detailed description of the presently preferred embodiments, read in conjunction with the accompanying drawings. The detailed description and drawings are merely illustrative of the invention, rather than limiting, the scope of the invention being defined by the appended claims and equivalents thereof.

### BRIEF DESCRIPTION OF THE DRAWINGS

FIG. 1 is an exaggerated view of a prior art vehicle damper assembly including a piston experiencing binding contact;

FIG. 2 is an exaggerated view of a vehicle damper assembly made in accordance with the present invention;

FIG. 3 is a perspective view of a vehicle damper assembly made in accordance with the present invention; and

FIG. 4 is a detailed perspective view of a portion of the vehicle damper assembly of FIG. 3.

### DETAILED DESCRIPTION OF THE PRESENTLY PREFERRED EMBODIMENTS

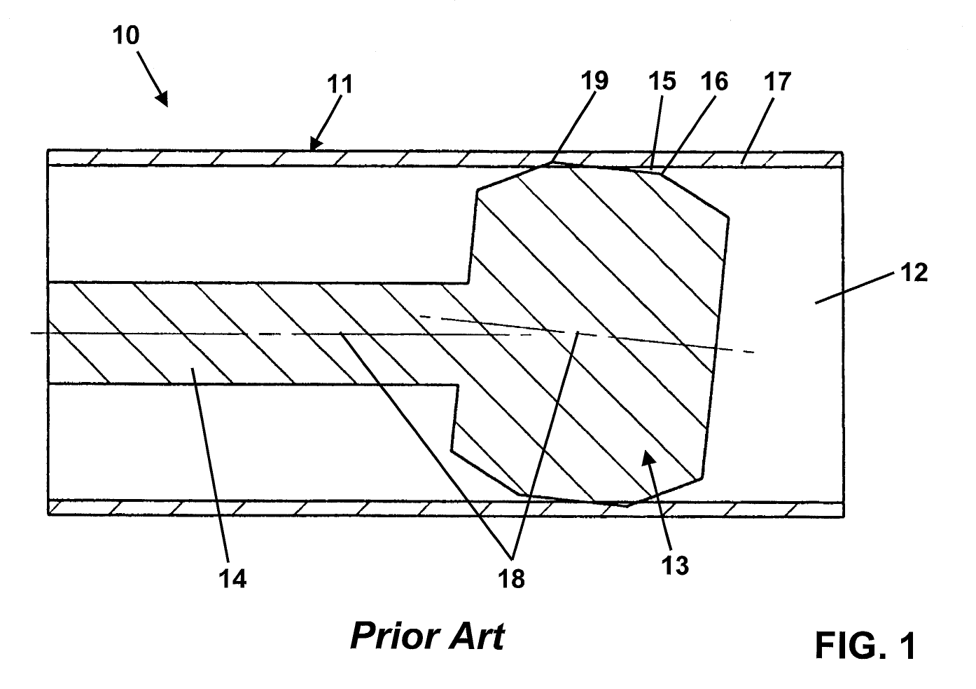

Referring to the drawings, FIG. 1 is an exaggerated view (i.e., not drawn to scale) of a prior art vehicle damper assembly shown generally by numeral 10. Vehicle damper assembly 10 may include a housing 11 including a fluid 12 carried therein, a piston 13 slidably carried in housing 11, and a rod 14 operably attached to piston 13.

During operation, piston 13 may move within housing 11 in response to vehicle suspension movements transmitted through rod 14. Piston 13 movements may force fluid 12 between at least one opening 15 formed between a piston surface 16 and housing inner surface 17. Vehicle suspension movements may be dampened by fluid frictional forces generated against piston 13 movements.

Vehicle damper assembly 10 is shown in a misaligned state (i.e., piston 13 and rod 14 do not share a common central axis 18). The misalignment may be due to variation in the assembly process. Misalignment may reduce opening 15 size and compromise hydrodynamic bearing resulting in repeated contact between surfaces 16, 17. The contact may produce excessive frictional wear thereby shortening damper assembly 10 lifespan. Misalignment may also promote binding contact between surfaces 16, 17. Piston 13, having a cylindrical shape, may experience binding contact, especially when misaligned. The binding contact may occur where piston surface 16 is angular in shape, such as at a corner portion 19. Excessive binding contact may cause piston 13 to “seize” within housing 11.

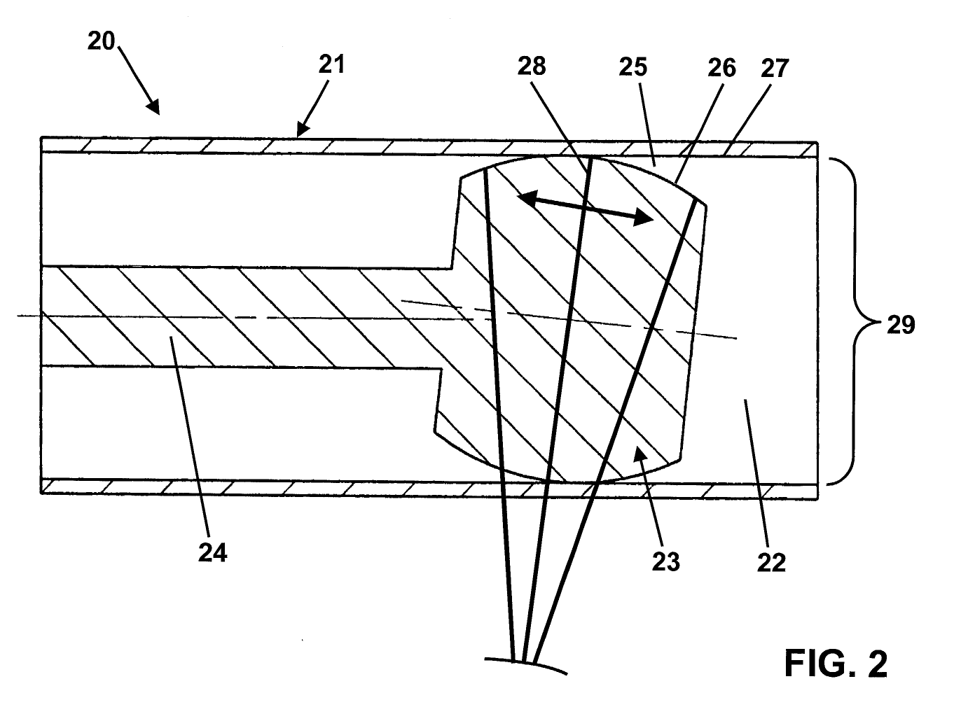

FIG. 2 is an exaggerated view of a vehicle damper assembly 20 made in accordance with the present invention. Vehicle damper assembly 20 may include a housing 21 including a fluid 22 carried therein, a piston 23 slidably carried in housing 21, and a rod 24 operably attached to piston 23. Piston 23 may include at least one curved portion 26 positioned adjacent a housing inner surface 27. In the following description, curved portion is defined as a curved surface that projects in an orthogonal direction from a piston central axis.

During operation, piston 23 may move within housing 21 in response to vehicle suspension movements transmitted through rod 24. Piston 23 movements may force fluid 22 between at least one opening 25 formed by piston curved portion 26 and housing inner surface 27. Vehicle suspension movements may be dampened by fluid frictional forces generated against piston 23 movements.

Vehicle damper assembly 20 is shown in a misaligned state. Curved portion 26 may contact housing inner surface 27 during vehicle damper assembly 20 operation, especially when the vehicle damper assembly 20 is misaligned. Curved portion 26 may reduce the consequences of vehicle damper assembly 20 misalignment. For example, curved portion 26 may provide means for maintaining hydrodynamic bearing between the curved portion 26 and housing inner surface 27. As such, curved portion 26 may reduce contact between housing 21 and piston 23 thereby reducing damper assembly 20 wear. Curved portion 26 may also provide means for reducing binding contact of surfaces 26, 27. A curved surface may be less likely to bind than an angular surface. As such, curved portion 26 may prevent piston 23 from seizing within housing 21.

Binding contact may be reduced by forming piston 23 with curved portion(s) 26 based on a longitudinal radius 28. The longitudinal radius 28 may be determined for a particular piston by considering the housing inner surface 27. In one embodiment, longitudinal radius 28 may be about 5 to 15 times a housing inner surface diameter 29. Preferably, the longitudinal radius 28 may be about 10 times housing inner diameter 29. A longitudinal radius 28 greater than 15 times inner surface diameter 29 may not provide enough curvature to reduce binding contact. A longitudinal radius 28 less than 5 times inner surface diameter 29 may provide excessive curvature thereby compromising hydrodynamic bearing.

The determined longitudinal radius 28 may then be partially rotated about a central point forming an arc or parabola (as shown by double arrow). Curved portion 26 may be based on the shape of the arc or parabola. In one embodiment, the longitudinal radius 28 may form a piston barrel shape (i.e., a cylindrical shape having a variable diameter, the diameter being wider near a middle portion than end portions). Thus, the piston barrel shape would include a generally cylindrical shape having bent sides based on the arc or parabolic shapes. The barrel shape may provide an acceptable shape for maintaining hydrodynamic bearing by providing a relatively long gap of effective engagement (i.e., area where curved portion 26 and housing inner surface 27 are substantially parallel and separated by a relatively small gap of fluid 22). Alternatively, a spherical shape may not provide as acceptable hydrodynamic bearing due to its relatively shorter gap of effective engagement. Those skilled in the art will recognize that the curved portion 26 need not be based on a simple arc or parabola. For example, curved portion 26 may be based on numerous simple and/or compound curved surfaces while providing the advantages associated with the present invention.

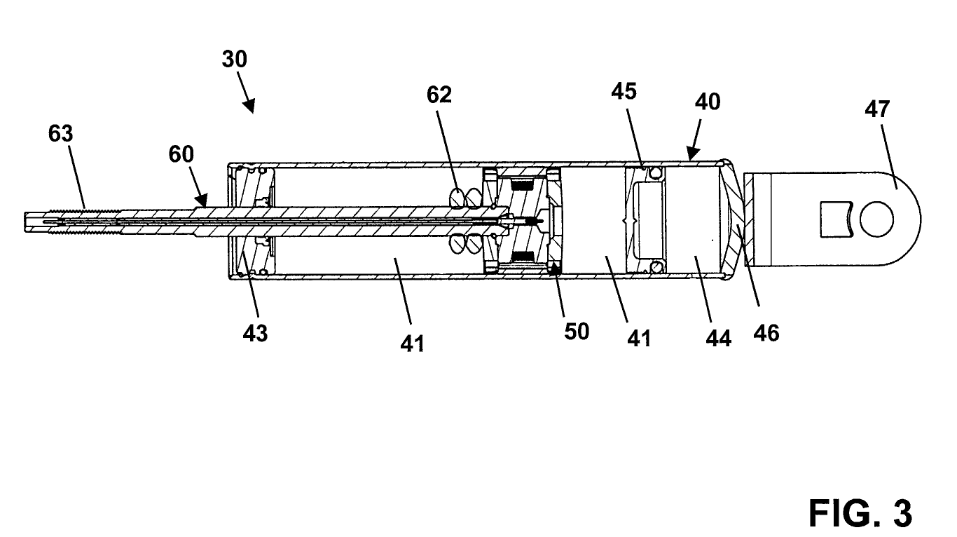

FIGS. 3 & 4, wherein like reference numerals refer to like elements, are perspective views of a vehicle damper assembly 30 made in accordance with the present invention. Those skilled in the art will recognize that vehicle damper assembly 30 may include a number of alternate damper designs. For illustrative purpose, vehicle damper assembly 30 is shown and described as a linear acting fluid damper employing magnetic tuning with a magnetorheological fluid to effect desired damping level.

Vehicle damper assembly 30 includes a housing 40 including a fluid 41 carried therein, a piston 50 slidably carried in housing 40, and a rod 60 operably attached to piston 50. The housing 40, piston 50, and rod 60 may be formed from a number of sufficiently rigid materials such as steel, aluminum, metal, metal alloy, composites, and the like. Fluid 41 may be any number of fluids used for providing dampening characteristics. In one embodiment, piston 50 may be formed from low-carbon steel with nickel plating and fluid 41 may be magnetorheological fluid. Low-carbon steel may provide electromagnetic induction properties compatible with magnetorheological fluid use.

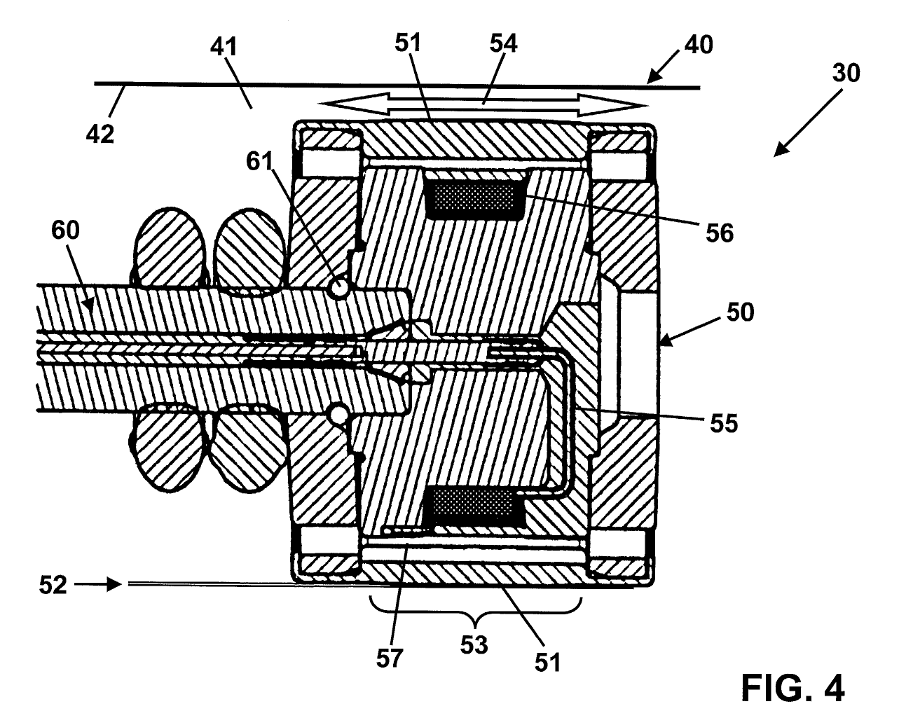

As shown in FIG. 4, piston 50 includes at least one curved portion 51 positioned adjacent a housing inner surface 42. In one embodiment, curved portion 51 extends from piston 50 surface outwardly for a profile distance 52 and length 53. The profile distance 52 and length 53 may be based on a longitudinal radius to maintain hydrodynamic bearing and reduce binding contact. In one embodiment, piston 50 may include curved portion 51 forming a barrel shape. The barrel shape may provide a relatively long gap of effective engagement 54 allowing fluid 41 to flow during piston 50 movement. In addition, the barrel shape may reduce binding contact between piston 50 and housing inner surface 42. Those skilled in the art will recognize that curved portion 51 shape, profile distance, length, and number may vary while providing the advantages associated with the present invention.

Piston 50 may include one or more wires 55 for providing electrical current to one or more coils 56. Fluid 41 may flow through one or more ports 57 formed through piston 50. The coils 56 provide means for modulating the viscosity of magnetorheological fluid 41 as it flows through ports 57 thereby effecting desired dampening level. Piston 50 may be attached to rod 60 with one or more ring clips 61 or other attachment means.

Referring again to FIG. 3, rod 60 may include one or more bumpers 62 to limit piston 50 range of motion and “quiet” piston 50 contact with a first housing end portion 43. Bumpers 62 may be formed from an elastic material compatible with fluid 41, such as a polyurethane material. Housing 40 may include a gas 44 contained by a cap 45 to provide a force against piston 50 as it travels toward a second housing end portion 46. Housing 40 and rod 60 may include a wheel assembly attachment means 47 and a vehicle chassis attachment means 63, respectively.

While the embodiments of the invention disclosed herein are presently considered to be preferred, various changes and modifications can be made without departing from the spirit and scope of the invention. For example, the damper assembly configuration, and method for determining a longitudinal radius are not limited to any particular design or sequence. Specifically, the curved portion shape, location, and number, the damper design, and longitudinal radius may vary without limiting the utility of the invention. Upon reading the specification and reviewing the drawings hereof, it will become immediately obvious to those skilled in the art that myriad other embodiments of the present invention are possible, and that such embodiments are contemplated and fall within the scope of the presently claimed invention. The scope of the invention is indicated in the appended claims, and all changes that come within the meaning and range of equivalents are intended to be embraced therein.

1. A vehicle damper assembly comprising:
a housing including a fluid carried therein;
a piston slidably carried in the housing, the piston including a curved portion, the curved portion positioned adjacent a housing inner surface; and
a rod operably attached to the piston.

2. The assembly of claim 1 wherein the fluid comprises magnetorheological fluid.

3. The assembly of claim 1 wherein the curved portion comprises a longitudinal radius.

4. The assembly of claim 3 wherein the longitudinal radius comprises a barrel shape.

5. The assembly of claim 1 wherein the curved portion contacts the housing inner surface during operation of the vehicle damper assembly.

6. The assembly of claim 1 wherein the curved portion comprises piston means for reducing binding contact between the curved portion and the housing inner surface.

7. The assembly of claim 1 wherein the curved portion comprises means for maintaining hydrodynamic bearing between the piston and the housing inner surface.

8. A vehicle damper assembly comprising:
housing means for carrying a fluid;
piston means from reducing binding contact with the housing means; and
rod means for moving the piston means.

9. The assembly of claim 8 wherein the fluid comprises magnetorheological fluid.

10. The assembly of claim 8 further comprising means for maintaining hydrodynamic bearing between the piston means and the housing means.

11. A method of reducing binding contact in a vehicle damper assembly comprising:
determining a longitudinal radius for a piston based on a housing inner surface;
forming the piston with a curved portion based on the longitudinal radius; and
positioning the curved portion adjacent the housing inner surface.

12. The method of claim 11 wherein positioning the curved portion adjacent the housing inner surface comprises maintaining hydrodynamic bearing between the piston and the housing inner surface.
